(19) United States
(12) Patent Application Publication
(10) Pub. No.: US 2026/0307480 A1
(43) Pub. Date: Oct. 8, 2026

(54) DRIVELINE ASSEMBLY PARK BRAKE FOR A WORK VEHICLE

(71) Applicant: Deere & Company, Moline, IL (US)

(72) Inventors: Kevin M. Allen, Bartlesville, OK (US); Martin L. Meek, JR., Coffeyville, KS (US)

(21) Appl. No.: 19/545,141

(22) Filed: Feb. 20, 2026

Related U.S. Application Data
(60) Provisional application No. 63/783,372, filed on Apr. 4, 2025.

(51) Int. Cl. B60K 23/08; F16D 25/12

(52) U.S. Cl. CPC B60K 23/0808; F16D 25/123

(57) ABSTRACT

A driveline assembly for a work vehicle includes a casing configured to couple thereto and defining an internal cavity containing cooling fluid, and a driveshaft at least partially disposed in the internal cavity and rotatable about a drive axis with respect to the casing. A friction pack is contained within the internal cavity and is arranged concentrically about the drive axis and includes a plurality of support plates alternately interleaved with a plurality of friction discs. The plurality of support plates have smooth opposite faces mounted for corotation with the driveshaft relative to the plurality of friction discs. The cooling fluid is limited to a maximum fill level within the internal cavity of the casing that is below the drive axis of the driveshaft such that a portion but not all of the bearing is submerged in the cooling fluid.

### CROSS-REFERENCE TO RELATED APPLICATION(S)

This application claims priority under 35 U.S.C. § 119(e) to U.S. provisional application Ser. No. 63/783,372, filed Apr. 4, 2025, which is incorporated herein in its entirety.

### STATEMENT OF FEDERALLY SPONSORED RESEARCH OR DEVELOPMENT

Not applicable.

### FIELD OF THE DISCLOSURE

This disclosure generally relates to braking systems for work vehicles and in particular a park brake system for work vehicles.

### BACKGROUND OF THE DISCLOSURE

Heavy-duty work vehicles, such as those used in the agricultural, construction, forestry, and mining industries, may utilize various propulsion systems and drive trains to provide tractive power to the ground-engaging members such as wheels or tracks for travel and work operations of the work vehicle. Such work vehicles typically include separate service and park brakes. Typically, the service brake is actuated to reduce speed of and/or bring to a stop a moving work vehicle. The park brake is typically actuated to keep the work vehicle stationary after the vehicle is stopped and the engine thereof is idling or operation of such engine has been terminated. However, there may be situations in which the park brake maybe actuated while the vehicle is in motion such as, for example, if operation of the service brake alone is inadequate to bring the moving vehicle to a stop.

### SUMMARY OF THE DISCLOSURE

The disclosure provides a driveline assembly for a work vehicle with a stand-alone park brake.

Specifically, the driveline assembly includes a casing configured to couple to the work vehicle and defining an internal cavity containing cooling fluid and a driveshaft. The driveshaft is at least partially disposed in the internal cavity, supported by a bearing, and rotatable about a drive axis with respect to the casing. The driveline assembly further includes a friction pack contained within the internal cavity of the casing and arranged concentrically about the drive axis. The friction pack includes a plurality of support plates and a plurality of friction discs alternatingly interleaved with the plurality of support plates. The plurality of support plates are mounted for corotation with the driveshaft relative to the plurality of friction discs, the friction discs are mounted to the casing or another component fixed with respect to the casing. Further, the plurality of friction discs extend radially outward from the drive axis farther than the plurality of support plates. The plurality of support plates have opposite faces that are smooth relative to the friction discs and the plurality of friction discs have opposite faces that are rough relative to the support plates. The cooling fluid limited to a maximum fill level below the drive axis of the driveshaft such that a portion but not all of the bearing is submerged in the cooling fluid.

The present disclosure also provides a work vehicle that includes a chassis carrying a power source, a plurality of ground-engaging members supporting the chassis off the ground, and a driveline carried by the chassis and configured to deliver power from the power source to the plurality of ground-engaging members. Further, the driveline assembly includes a casing configured to couple to the work vehicle and defining an internal cavity containing cooling fluid and a driveshaft. The driveshaft is at least partially disposed in the internal cavity, supported by a bearing and rotatable about a drive axis with respect to the casing. In addition, a friction pack is contained within the internal cavity of the casing and arranged concentrically about the drive axis. The friction pack includes a plurality of support plates and a plurality of friction discs alternatingly interleaved with the plurality of support plates. The plurality of support plates are mounted for corotation with the driveshaft relative to the plurality of friction discs, the friction discs are mounted to the casing or another component fixed with respect to the casing, and the plurality of friction discs extend radially outward from the drive axis farther than the plurality of support plates. In addition, the plurality of support plates have opposite faces that are smooth relative to the friction discs and the plurality of friction discs have opposite faces that are rough relative to the support plates. The cooling fluid limited to a maximum fill level within the internal cavity of the casing that is below the drive axis of the driveshaft such that a portion but not all of the bearing is submerged in the cooling fluid.

In some aspects or embodiments, the internal cavity of the casing is filled with cooling fluid to a fill level that is above a zone in which the plurality of support plates and the plurality of friction discs overlap radially. In some further aspects, the fill level is radially closer to the drive axis than a radially inner periphery of the plurality of friction discs.

In some aspects or embodiments, the plurality of support plates is splined to the drive shaft so as to be movable along the drive axis and the plurality of friction discs are splined to the casing so as to be movable along the drive axis.

In some aspects or embodiments, the driveline assembly also includes an actuator that selectively engages and disengages the friction pack so that when the actuator is engaged with the friction pack, the plurality of friction discs are positioned to impede rotation of the plurality of support plates, and, when the actuator is disengaged from the friction pack, the plurality of friction discs are positioned to permit rotation of the plurality of support plates. Further, in some cases, the casing device a piston chamber and the actuator includes a piston disposed in the piston chamber and movable by hydraulic pressure to engage or disengage the friction pack. In addition, the driveline assembly may include a piston spring acting on the piston to bias the piston to engage the friction pack and hydraulic pressure within the piston chamber drives the piston against the piston spring to disengage the piston from the friction pack.

In some aspects or embodiments, the driveshaft extends along the drive axis beyond the casing to opposite ends that mount clevis components.

In some aspects or embodiments, the plurality of friction discs is comprised of metallic discs that back frictional material, the metal discs having opposite smooth faces to which attach smooth faces of the frictional material. The frictional material define the rough opposite faces and the one or more passages of the plurality of friction discs.

In some aspects, the portion of the driveshaft disposed in the internal cavity is intermediate a transmission and a differential of the work vehicle.

In some aspects, the maximum fill level of the cooling fluid is at least 45 millimeters below the drive axis.

### BRIEF DESCRIPTION OF THE DRAWINGS

FIG. 1 is an example work vehicle in the form of an agricultural tractor in which a park brake of the present disclosure may be incorporated;

FIG. 2 is a schematic diagram of a portion of an example driveline assembly including the park brake of the work vehicle of FIG. 1;

FIG. 3 is an isometric view of a park brake of the driveline assembly of FIG. 2;

FIG. 4 is an isometric sectional view of the park brake of FIG. 3 taken along a line 4-4 of FIG. 3 with parts omitted for clarity;

FIG. 5 is an elevational sectional view of the portion of the park brake shown in FIG. 4, with additional parts omitted for clarity;

FIG. 6 is an elevational view of a support plate of the park brake of FIG. 3; and

FIG. 7 is an isometric sectional view of the portion of the park brake shown in FIG. 4 with parts omitted to show a friction disc disposed in a casing of the park brake.

Like reference symbols in the various drawings indicate like elements.

### DETAILED DESCRIPTION

The following describes one or more example embodiments of the disclosed driveline assembly having a park brake for a work vehicle as shown in the accompanying figures of the drawings described briefly above. Various modifications to the example embodiments may be contemplated by one of skill in the art. Discussion herein focuses on the driveline assembly being for a work vehicle, such as an agricultural tractor, but the driveline assembly disclosed herein may be utilized in other contexts, including other work vehicle platforms in the agriculture, construction, forestry, mining, and other industries.

### OVERVIEW

A work vehicle includes a chassis, a power generating engine and/or motor(s), a transmission, a plurality of ground-engaging members (e.g., wheels or tractors), and a driveline. The driveline transfers power generated by the engine and/or motor(s) through the transmission and to the ground-engaging members to provide tractive power thereto. In particular, driveline includes a driveshaft, one or more axles, and one or more differentials that couple the driveshaft to corresponding ones of the one or more axles. Power is transmitted to the driveshaft by the transmission to cause rotation of the driveshaft and such rotation causes rotations of the one or more axles via the differential. The work vehicle also includes a service brake, a park brake separate from the service brake, and a park brake control. As would be understood by one who has ordinary skill in the art, the service brake may be disposed on the axle proximate to the one or more ground-engaging members to cause the vehicle when in motion to slow down and/or to stop.

The park brake in accordance with the present disclosure is disposed along the driveshaft between the transmission and the differential and is typically engaged after the work vehicle is stopped to inhibit rotation of the driveshaft and thereby prevent unintended rolling or other motion of the work vehicle. However, the park brake may be engaged in an emergency situation to assist the service brake in slowing down or stopping the vehicle. Further, an operator may inadvertently engage the park brake while the vehicle is in motion but such engagement is atypical. The park brake includes a casing secured to the chassis or other fixed component of the work vehicle and the casing defines an internal cavity. A portion of the driveshaft is disposed in the cavity and a friction pack is circumferentially disposed between the portion of the driveshaft and the casing. The friction pack includes a plurality of friction discs and a plurality of support plates interleaved with one another. The friction discs are secured to the casing and because the casing is secured to the chassis of the work vehicle remain stationary while the driveshaft rotates. The support plates are secured to the portion of the driveshaft in the casing so that the support plates rotate synchronously with the driveshaft. The friction discs and support plates are separated from one another when the park brake is not engaged so corotation of the support plates with the drive shaft is not impeded by the friction discs. However, as described in detail below, engagement of the park brake causes the plurality of friction discs and the plurality of support plates to move relative to one another until each friction disc engages an adjacent support plate and thereby impedes the rotation of such support plate. Impeding rotation of the plurality of support plates in this manner impedes rotation of the drive shaft to which such support plates are secured and thereby prevents inadvertent motion of the ground-engaging members of the work vehicle. The plurality of friction discs and the plurality of support plates remain in contact in this manner until the park brake is disengaged.

In some embodiments, the park brake is a spring applied hydraulically released brake (SAHR) that includes a hydraulically driven piston and a spring assembly comprising, for example, one or more Belleville springs disposed circumferentially about the driveshaft. In some embodiments, hydraulic fluid applies force to the piston to drive the piston against the Belleville springs and thereby hold the Belleville springs in a compressed or loaded state when the park brake is disengaged. Operation of the park brake control to engage the park brake causes hydraulic fluid to be pumped out of or otherwise evacuated from the park brake, which releases the force driving the piston against the Belleville springs and thereby causes the Belleville springs to move from the compressed state to a flattened state and thereby drive the piston toward the friction pack and move the plurality of support plates and the plurality of friction discs relative to one another until each of the plurality of support plates contacts an adjacent one of the plurality of friction discs. Such contact generates friction between the plurality of support plates and the plurality of friction discs and impedes rotation of the support plates and, thus, the driveshaft on to which such support plates are disposed.

Further, the operator may operate the park brake control to disengage the park brake, which causes flow of hydraulic fluid into the park brake that drives the piston away from the friction pack and toward the Belleville springs to cause such springs to return to and be held in the compressed state. Movement of the piston away from the friction pack allows the plurality of support plates to separate from plurality of friction discs so that the plurality the support plates may corotate in with the driveshaft.

Alternatively, the Belleville springs may be held in the flattened (unloaded) state when the park brake is not engaged and operation the park brake control causes the hydraulic fluid to be pumped or supplied into the park brake and thereby cause the Belleville springs to move from the flattened state to the compressed state to drive the piston move toward the friction pack to force the plurality of support plates toward the plurality of friction discs to impede rotation of the driveshaft. Thereafter, the operator may operate the park brake control to disengage the park brake, which causes the hydraulic fluid to be pumped or evacuated out of the park brake and thereby return the Belleville spring to the flattened state and allow the support plates to rotate relative to the friction discs as described above.

The portion of the drive shaft enclosed in the casing of the park break is supported by one or more bearings secured to the casing. Rotation of the driveshaft in these bearings generates heat that must be drawn away from the bearings and bearing components (e.g., bearing rollers, etc.). However, because the park brake is typically engaged when the vehicle is stationary and the draft shaft is not rotating, engaging the park brake does not generate sufficient friction between the friction discs and the support plates that results in heat that has to be drawn away. In some embodiments, a reduced amount of cooling fluid may be provided in the park brake compared to conventional brakes (e.g., service brakes). The amount of cooling fluid is sufficient to draw away heat generated by rotation of driveshaft within the bearings but not heat generated from engagement of the friction discs with the support plates. Reducing the amount of cooling fluid reduces the amount of cooling fluid that may be drawn onto faces of the friction discs and the support plates during operation of the vehicle and thereby reduces windage (i.e., fluid drag) when the drive shaft is rotating (i.e., the vehicle is in motion) that may reduce the power available to transport or otherwise operate the vehicle. The cooling fluid draws heat away from the components of the bearings and disperses such heat to the driveshaft and the casing, and thereby to the ambient environment. In some embodiments, the amount of cooling fluid supplied in the park brake is sufficient to submerge only a portion of the bearings that is intermediate the casing and the drive axis and a fill level of the cooling fluid is below a drive axis of the drive shaft (i.e., the fill level is intermediate the drive axis and casing).

### EXAMPLE PARK BRAKE

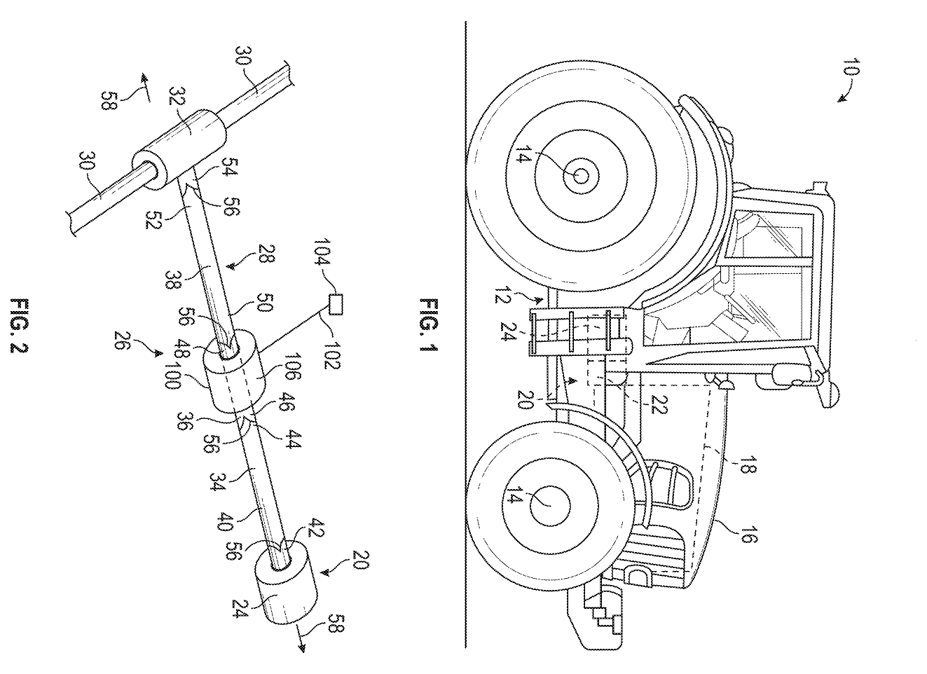

Referring to FIGS. 1 and 2, a work vehicle 10 is shown that can implement embodiments of the present disclosure. In the illustrated example, the work vehicle 10 is depicted as an agricultural tractor. It will be understood, however, that other configurations may be possible, including configurations with the work vehicle 10 as a different kind of tractor, a harvester, a log skidder, a grader, or one of various other work vehicle platforms. The work vehicle 10 includes a chassis or frame 12 carried on front and rear ground-engaging members, such as tracks or wheels 14. Positioned on a forward end region of the chassis 12 is an engine housing 16 within which is located an engine system 18. The engine system 18 provides power via an associated powertrain 20 comprising for example, an engine 22 and a transmission 24, to a driveline assembly 26. The driveline assembly 26 includes a driveshaft 28 that, in turn, transmits power to one or more axles 30 via a differential 32. The powertrain 20 may also provide power to a power take-off shaft for powering an implement on or associated with the work vehicle 10, for example.

The driveshaft 28 includes a transmission-side portion 34, a central portion 36, and an axle-side portion 38. A first end 40 of the transmission-side portion 34 of the driveshaft 28 is secured to an output shaft 42 of the transmission 24 and a second end 44 of the transmission-side portion 34 is secured to a first end 46 of the central portion 36. A second end 48 of the central portion 36 of the driveshaft 28 is secured to a first end 50 of the axle-side portion 38 of the driveshaft 28. A second end 52 of the axle-side portion 38 is secured to an input shaft 54 of a differential 32. In one embodiment, clevises or other attachment assemblies 56 and associated components may be used to secure the transmission-side portion 34 of the driveshaft 28 to the output shaft 42 of the transmission 24, the central portion 36 of the driveshaft 28 to the transmission-side portion 34 and the axle-side portion 38 of the driveshaft 28, and the axle-side portion 38 to the input shaft 54 of the differential 32. Other ways of attaching the portions 34,36, 38 of the driveshaft 28 to one another and to secure the driveshaft 28 to the output shaft 42 of the transmission 24 and the input shaft 54 of the differential 32 apparent to one who has ordinary skill in the art may be used in other embodiments.

During operation, the transmission 24 uses power generated by the engine 22 to rotate the output shaft 42 thereof. Rotation of the output shaft 42 causes simultaneous rotation of the driveshaft 28 (i.e., the transmission-side portion 34, the central portion 36, and the axle-side portion 38 thereof) about a drive axis 58 (i.e., axis of rotation) thereof, and rotation of driveshaft 28 is transmitted by the differential 32 to the axles 30 to cause rotation thereof.

A park brake 100 is disposed on and surrounds the central portion 36 of the driveshaft 28. The park brake 100 is coupled, for example, by a rod, a cable, a hydraulic assembly, and the like 102 to a park brake control 104. The park brake control 104 may be a lever, a button, or other control mechanism operable by an operator to engage and disengage the park brake 100. The park brake 100 includes a casing 106 and the central portion 36 of the drive shaft 28 passes through the casing 106.

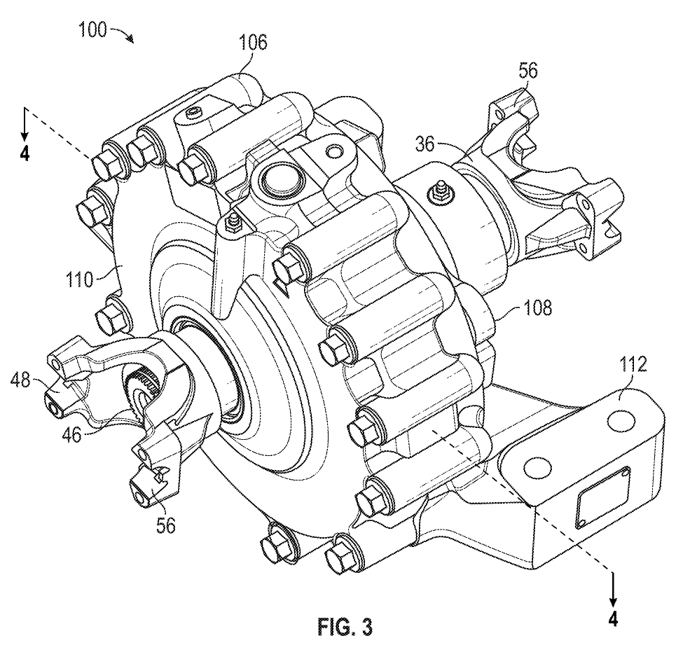

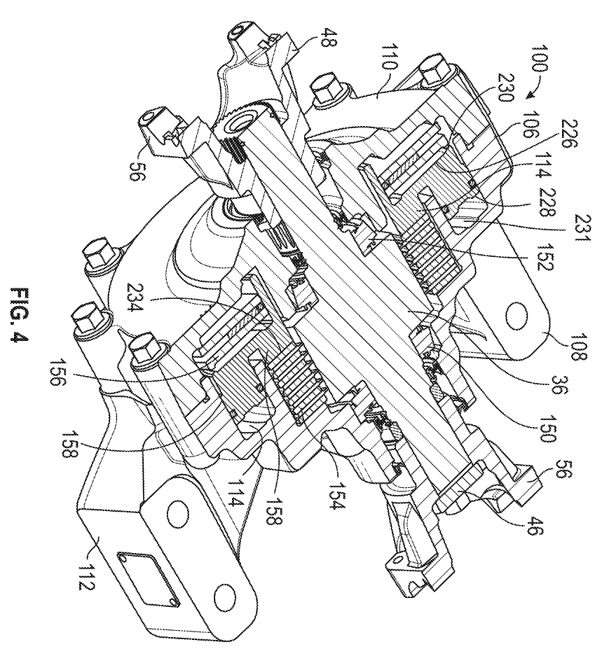

Referring also to FIGS. 3-7, the casing 106 comprises a transmission-side sub-casing 108 and an axle side sub-casing 110. In some embodiments, the transmission-side sub-casing 108 includes a park brake mount 112 that may be fixedly secured to the chassis 12 or another fixed element of the work vehicle 10 so that the casing 106 remains stationary while the central portion 36 rotates in response to power generated by the engine 22. In other embodiments. the park brake mount 112 may be disposed on the axle-side sub-casing 110.

The transmission-side sub-casing 108 and the axle-side sub-casing 110 are joined together to form the casing 106 that defines a cavity 114 in which the components of the park brake 100 are disposed. Such components include a transmission-side bearing 150, an axle side bearing 152, a friction pack 154, and a park brake actuator 155 that includes a piston spring assembly 156 and a piston casing 158. The friction pack 154, the piston spring assembly 156, and the piston casing 158 are disposed circumferentially about and surround the central portion 36 (and thus the drive axis 58).

The central portion 36 includes a splined hub 160. The transmission-side bearing 150 and the axle side bearing 150 are disposed on opposite sides of the splined hub 160 along the drive axis 58. The first end 46 of the central portion 36 of the driveshaft 28 is passed through and supported by the transmission-side bearing 150 and the second end 48 of the central portion 36 is passed through and supported by the axle-side bearing 152. In some embodiments, one or both of the transmission-side bearing 150 and the axle-side bearing 152 are journaled bearings that allow rotation of the central portion 36 of the driveshaft 28 relative to the casing 106. Other types of bearings and support members instead of or in addition to the bearings 150, 152 that can support and facilitate such rotation of the central portion 36 apparent to one who has ordinary skill in the art may be used in other embodiments.

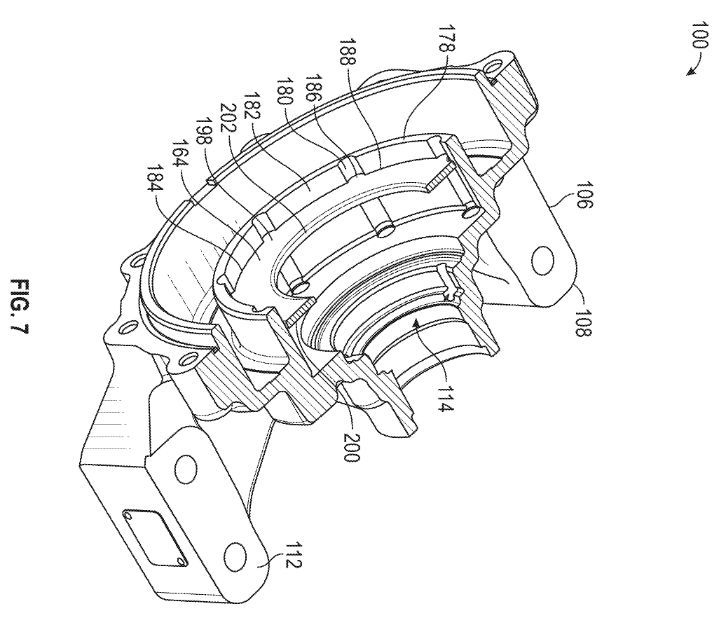

The splined hub 160 is configured to corotate with the central portion 36. In some embodiments, the splined hub 160 is a component separate from the central portion 36 that is secured thereto and in other embodiments the splined hub 160 is integrally formed with the central portion 36. The friction pack 154 surrounds the splined hub 160 and includes a plurality of support plates 162 and a plurality of friction discs 164 interleaved with one another. The splined hub 160 includes a plurality of keys or splines 166 separated by a plurality of grooves 168. The plurality of keys 166 and the plurality of grooves 168 of the splined hub 160 extend along a direction parallel to the drive axis 58 and are distributed circumferentially about the splined hub 160. Each support plate 162 (see FIG. 6) is an annular disc having in inner periphery 170. A plurality of protrusions 172 extend inwardly from the inner periphery 170 and adjacent protrusions 172 form a notch 174 therebetween. The plurality of notches 174 and the plurality of protrusions 172 are sized and formed to mate with corresponding keys 166 and grooves 168 of the splined hub 160 as each support plate 162 is slid on to the splined hub 160 in a direction parallel to the drive axis 58. Thus, each support plate 162 is supported by the splined hub 160 so that the support plate 162 corotates with the splined hub 160 yet is able to move along the splined hub 160 in a direction parallel to the drive axis 58. Other ways apparent to one who has ordinary skill in the art to dispose the plurality of support plates 162 on the central portion 36 so that the plurality of support plates 162 are movable in a direction parallel to the drive axis 58 and corotate with the central portion 36 may be used in other embodiments.

In some embodiments, as shown in FIG. 7, at least a portion an inner wall 178 of the transmission-side sub-casing 108 is splined and includes a plurality of grooves 180 and a plurality of keys or inwardly extending sections 182 defined by adjacent grooves 180. Each of the plurality of friction discs 164 is an annular disc having an outer periphery 184. Extending outwardly from the outer periphery 184 of each friction disc 164 are a plurality of protrusions 186 and a plurality of grooves or inwardly extending sections 188. Each friction disc 164 is disposed in the transmission-side sub-casing 108 so that the protrusions 186 and the grooves 188 on the outer periphery 184

of the friction disc 164 mate with the keys 182 and grooves 180, respectively, in the inner wall 178 of transmission-side sub-casing 108. As noted above, the transmission-side sub-casing 108 is immovably secured to the chassis 12 or another fixed component of the work vehicle 10 so that such sub-casing 108 does not corotate with the driveshaft 28 (FIG. 2). Thus, disposing each friction disc 164 in the sub-casing 108 in this manner prevents corotation of the friction disc 164 with the driveshaft 28 and allows the friction disc 164 to move relative to the transmission-side sub-casing 108 in a direction parallel to the drive axis 58.

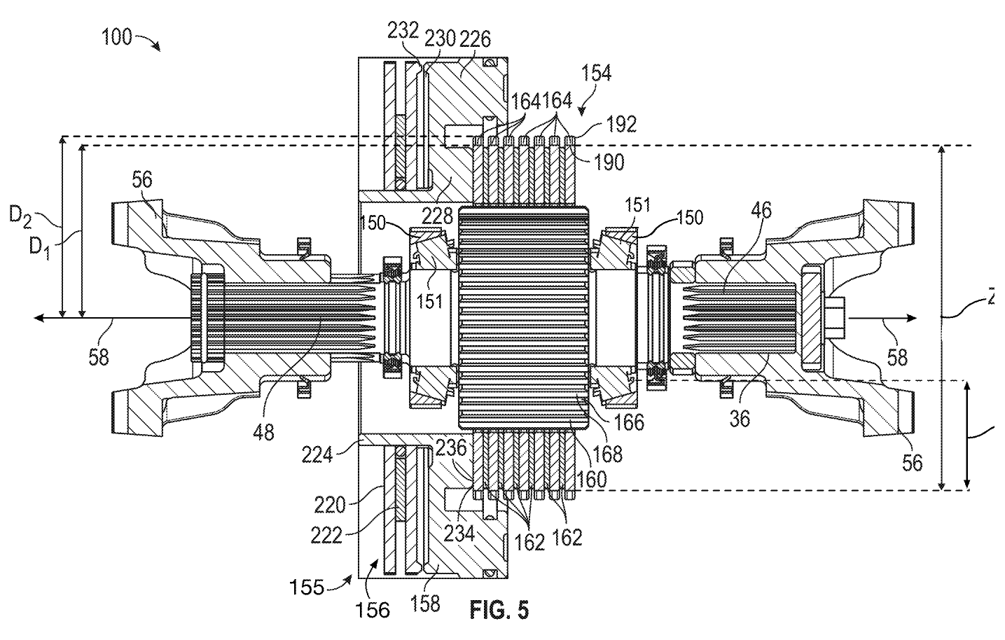

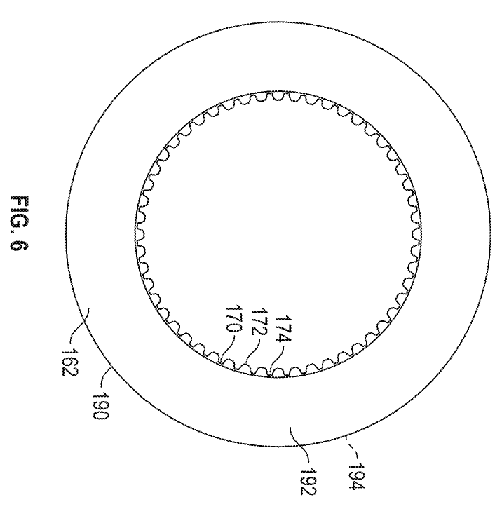

As illustrated in FIG. 5, in some embodiments, the plurality of support plates 162 and the plurality of friction discs 164 extend radially from the drive axis 58 such that a distal end 190 of the support plate 162 is a distance D₁ from the drive axis and a distal end 192 of the friction disc is a distance D₂ from the drive axis and the distance D₂ is greater than the distance D₁. First and second opposite faces 194, 196 of each of the plurality of support plates 162 are substantially smooth and first and second opposite faces 198, 200 of each of the plurality of friction discs 164 is roughened for example, by having a friction material disposed thereon. In some embodiments, the faces 198, 200 of the friction disc 164 may also have grooves or channels (not shown) formed therein that extend radially from an inner periphery 202 of the friction disc 164 to the outer periphery 184.

In some embodiments, the cavity 114 defined by the casing 106 is filled with sufficient cooling fluid that portions less than the entirety of the bearings 150, 152 below the drive axis are submerged in the cooling fluid. Submerging portions of the bearings 150, 152 allows circulation of the cooling fluid through the components of the bearings 150, 152 to draw away heat from such components to other parts of the park brake 100. For example, the cooling fluid may distribute such heat to the casing 106 and to the central portion 36 of the driveshaft 28, which in turn radiates the heat to the ambient environment. In some cases, portions the plurality of support plates 162 and the plurality of friction discs 164 completely overlap radially in a zone Z₁. In other cases, the fill level of the cooling fluid is sufficient to submerge a zone, for example, zone Z₂, between the casing and a level intermediate the casing and the drive axis 58 of the drive shaft 20 that includes portions of the bearings 150,152 and portions of rollers 151 associated with such bearings 150,152. The portions of the bearings 150,152 and the portions of the rollers 151 in zone Z₂ are less than the sections of such bearings and rollers that are disposed below the drive axis 58. In some embodiments, the maximum fill level of the cooling fluid is within zone Z₂ and may be from about 30 millimeters to about 55 millimeters below the drive axis 58, from about 40 millimeters to about 45 millimeters, at least 45 millimeters below the drive axis 58, or at least 55 millimeters below the drive axis 58. In some embodiments, the volume of the cooling fluid may be less than about 450 milliliters and, in some cases, between 425 milliliters to about 450 milliliters. Reducing the amount of cooling fluid in the casing 106 reduces the amount of cooling fluid that may be drawn between the support plates 162 and the friction discs 164 when the drive shaft 28 is rotating and consequently reduces fluid drag or windage imposed on the drive shaft 28 by the drawn cooling fluid compared to conventional brake systems.

In one embodiment, the piston spring assembly 156 of the park brake actuator 155 includes one or more Belleville spring(s) 220 separated by one or more spacer(s) 222. Each Belleville spring 220 and spacer 222 is an annular disc that surrounds the central portion 36 of the drive shaft 28. The piston casing 158 is configured to be movable parallel to the drive axis 58 and includes an annular flange 224 that passes through central openings of the one or more Bellville spring(s) 220 and the one or more spacer(s) 222. A piston 228 is disposed in the piston casing 158 between the spring assembly 156 and the friction pack 154 and is configured to be movable in a direction parallel to the drive axis 58 of the driveshaft 28. The piston 228 includes a spring side portion 226 having at least one protrusion 230 extending therefrom toward the spring assembly 156. Each protrusion 230 is in contact with a corresponding protrusion 232 (FIG. 5) on the Belleville spring 220 proximate the spring side portion 226. Further, the piston 228 is disposed in the piston casing 158 such that a hydraulic fluid chamber 231 is formed therebetween.

In some embodiments, when the park brake 100 is disengaged, hydraulic fluid is pumped or supplied into the hydraulic fluid chamber 231 to apply pressure to and drive the piston 228 toward the one or more Belleville spring(s) 220 to hold such spring(s) 220 in a loaded state. Further, driving the piston 228 in this manner separates a wall 234 of the piston 228 from a face 236 (i.e., one of the opposite faces 198, 200) of the friction disc 164 nearest the piston 228. In addition, the face 198 or 200 of each friction disc 164 is separated from the face 194 or 196 of the support plate 162 adjacent to such friction disc 164. Thus, the plurality of support plates 162 are free to corotate with the central portion 36 without being impeded by the plurality of friction discs 164. In such embodiments, the park brake control 104 may be operated to engage the park brake 100 by pumping or evacuating the hydraulic fluid from hydraulic fluid chamber 231, thereby releasing the pressure applied to the piston 228 and allowing the one or more Belleville spring(s) 220 to release (i.e., deload). In particular, releasing the one or more Belleville spring(s) 220 causes the protrusion 232 on the Bellville spring 220 to move toward and push against the protrusion 230 on the spring side portion 226 of the piston 228 and thereby drive the piston 228 toward the friction pack 154. The piston 228 moves toward the friction pack 154 until the wall 234 of the piston 228 contacts the face 236 of the friction disc 164 nearest the piston 228 and continues to drive the faces 198 or 200 of the plurality of friction discs 164 into contact with adjacent faces 194 or 196 of the plurality of support plates 162. The one or more Belleville spring(s) 220 and the piston 228 are configured to force the plurality of friction discs 164 toward the plurality of support plates 162 in this manner to cause friction between the friction discs 164 and support plates 162 that impedes corotation of the plurality of support plates 162 with the central portion 36 of the drive shaft 28. Further, operating the park brake control 104 to re-engage the park brake 100 causes the hydraulic fluid to be pumped or supplied into the hydraulic fluid chamber 231 which once again applies pressure to the piston 228 to drive the piston toward the one or more Belleville springs 220 until the Belleville spring 220 return to the reloaded state described above. Moving the piston 228 in this manner stops the piston portion 228 from urging the plurality of friction discs 164 toward the plurality of support plates 162, which in turn causes separation of the friction discs 164 and the support plates 162 and allows the plurality of support plates 162 to corotate with the central portion 36 of the driveshaft 28.

In other embodiments, the Belleville springs 220 are in a released state when the park brake 100 is disengaged and operating the park brake control 104 causes pumping of hydraulic fluid into the chamber 231, which causes loading of the Belleville springs 220 that results in movement of the friction discs 164 toward the support plates 162 as discussed above. In some such cases, the Belleville springs 220 may be disposed between the hydraulic fluid chamber 231 and the piston 228. It should be apparent to one who has ordinary skill in the art that the piston spring assembly 156 may use springs other than Belleville springs 220 and that the park brake actuator may include additional components (e.g., a hydraulic assist, solenoids, and the like) to facilitate movement of the friction discs 164 toward the support plates 162.

In some embodiments, each friction disc 164 comprises a metal disc having opposite smooth faces to which frictional material is attached to define the opposite rough faces 198,200 of each friction disc. As noted above, each friction disc 164 is held stationary when the drive shaft 28 rotates during operation of the vehicle 10. Holding the friction disc 164 stationary may prevent the cooling fluid being drawn on to the faces 198,200 of the friction disc 164 when the drive shaft 28 is rotating and, thus prevent fluid drag or windage caused by such drawn cooling fluid that may reduce the power available for operation of the work vehicle 10.

In some embodiments, each support plate 162 comprises a metal disc and the faces 194, 196 of such support plates are substantially smooth. Further, each support plate is sufficiently thick to absorb energy generated during operation of the park brake 100 during a high energy stop such as in an emergency or if the park brake 100 is accidentally engaged when the work vehicle 10 is in motion. The amount of friction caused by interaction of the support plates 162 and frictions discs 164 during normal operation the park brake 100 after the vehicle 10 is stopped does not generate sufficient heat that has to be drawn away by the cooling fluid to prevent damage to the components of the park brake 100. However, friction between the support plates 162 and 164 if the park brake 100 is used when the vehicle 10 is in motion during the high energy stop may generate more heat that has to be drawn away and such heat may be drawn away by the support plates 162 and distributed to the ambient environment via the casing 106 and or drive shaft 28.

The park brake 100 disclosed herein includes one or more seals (not shown) such as, for example, O-rings and the like apparent to one who has ordinary skill in the art to prevent unwanted flow or leakage of the cooling fluid from the cavity 114 and the hydraulic fluid from the hydraulic fluid chamber 231 into other parts of the park brake 100 or to the exterior of the park brake 100.

Although the embodiments disclosed herein are described in connection with a park brake for a work vehicle, it should be apparent to one who has ordinary skill in the art that aspects of these embodiments may be adapted to other types of braking systems and/or other types of vehicles to reduce windage caused by cooling fluid in such braking system that are typically used after the vehicle is stopped. Further, aspects of such embodiments may even be used in other types of engines or motors not associated with vehicles as appropriate.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

The description of the present disclosure has been presented for purposes of illustration and description, but it is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A driveline assembly for a work vehicle comprising:
a casing configured to couple to the work vehicle and defining an internal cavity containing cooling fluid;
a driveshaft at least partially disposed in the internal cavity, supported by a bearing, and rotatable about a drive axis with respect to the casing; and
a friction pack contained within the internal cavity of the casing and arranged concentrically about the drive axis, the friction pack including a plurality of support plates and a plurality of friction discs alternatingly interleaved with the plurality of support plates, the plurality of support plates being mounted for corotation with the driveshaft relative to the plurality of friction discs, the friction discs being mounted to the casing or another component fixed with respect to the casing, the plurality of friction discs extending radially outward from the drive axis farther than the plurality of support plates, the plurality of support plates having opposite faces that are smooth relative to the friction discs and the plurality of friction discs having opposite faces that are rough relative to the support plates;
wherein the cooling fluid is limited to a maximum fill level within the internal cavity of the casing that is below the drive axis of the driveshaft such that a portion but not all of the bearing is submerged in the cooling fluid.

2. The driveline assembly of claim 1, wherein the fill level is radially closer to the drive axis than a radially inner periphery of the plurality of friction discs.

3. The driveline assembly of claim 1, wherein the plurality of support plates is splined to the drive shaft so as to be movable along the drive axis and the plurality of friction discs are splined to the casing so as to be movable along the drive axis.

4. The driveline assembly of claim 1, further including an actuator that selectively engages and disengages the friction pack;
wherein, when the actuator is engaged with the friction pack, the plurality of friction discs are positioned to impede rotation of the plurality of support plates, and, when the actuator is disengaged from the friction pack, the plurality of friction discs are positioned to permit rotation of the plurality of support plates.

5. The driveline assembly of claim 4, wherein the casing includes a piston chamber; and
wherein the actuator includes a piston disposed in the piston chamber and movable by hydraulic pressure to engage or disengage the friction pack.

6. The driveline assembly of claim 5, further including a piston spring acting on the piston to bias the piston to engage the friction pack;
wherein hydraulic pressure within the piston chamber drives the piston against the piston spring to disengage the piston from the friction pack.

7. The driveline assembly of claim 1, wherein the driveshaft extends along the drive axis beyond the casing to opposite ends that mount clevis components.

8. The driveline assembly of claim 1, wherein the plurality of friction discs is comprised of metallic discs that back frictional material, the metal discs having opposite smooth faces to which attach smooth faces of the frictional material, the frictional material defining the rough opposite faces and the one or more passages of the plurality of friction discs.

9. The driveline assembly of claim 1, wherein the portion of the driveshaft disposed in the internal cavity is intermediate a transmission and a differential of the work vehicle.

10. The driveline assembly of claim 1, wherein the maximum fill level of the cooling fluid is at least 45 millimeters below the drive axis.

11. A work vehicle comprising:
a chassis carrying a power source;
a plurality of ground-engaging members supporting the chassis off the ground;
a driveline carried by the chassis and configured to deliver power from the power source to the plurality of ground-engaging members, the driveline including:
a casing configured to couple to the work vehicle and defining an internal cavity containing cooling fluid;
a driveshaft at least partially disposed in the internal cavity and rotatable about a drive axis with respect to the casing; and
a friction pack contained within the internal cavity of the casing and arranged concentrically about the drive axis, the friction pack including a plurality of support plates and a plurality of friction discs alternatingly interleaved with the plurality of support plates, the plurality of support plates being mounted for corotation with the driveshaft relative to the plurality of friction discs, the friction discs being mounted to the casing or another component fixed with respect to the casing, the plurality of friction discs extending radially outward from the drive axis farther than the plurality of support plates, the plurality of support plates having opposite faces that are smooth relative to the friction discs and the plurality of friction discs having opposite faces that are rough relative to the support plates;
wherein cooling fluid is limited to a maximum fill level within the internal cavity of the casing that is below the drive axis of the driveshaft such that a portion but not all of the bearing is submerged in the cooling fluid.

12. The work vehicle of claim 11, wherein the fill level is radially closer to the drive axis than a radially inner periphery of the plurality of friction discs.

13. The work vehicle of claim 11, wherein the plurality of support plates is splined to the drive shaft so as to be movable along the drive axis and the plurality of friction discs are splined to the casing so as to be movable along the drive axis.

14. The driveline assembly of claim 13, further including an actuator that selectively engages and disengages the friction pack;
wherein, when the actuator is engaged with the friction pack, the plurality of friction discs are positioned to impede rotation of the plurality of support plates, and, when the actuator is disengaged from the friction pack, the plurality of friction discs are positioned to permit rotation of the plurality of support plates.

15. The work vehicle of claim 14, wherein the casing includes a piston chamber; and
wherein the actuator includes a piston disposed in the piston chamber and movable by hydraulic pressure to engage or disengage the friction pack.

16. The work vehicle of claim 15, further including a piston spring acting on the piston to bias the piston to engage the friction pack;
wherein hydraulic pressure within the piston chamber drives the piston against the piston spring to disengage the piston from the friction pack.

17. The work vehicle of claim 11, wherein the driveshaft extends along the drive axis beyond the casing to opposite ends that mount clevis components.

18. The work vehicle of claim 11, wherein the plurality of friction discs is comprised of metallic discs that back frictional material, the metal discs having opposite smooth faces to which attach smooth faces of the frictional material, the frictional material defining the rough opposite faces and the one or more passages of the plurality of friction discs.

19. The work vehicle of claim 11, wherein the portion of the driveshaft disposed in the internal cavity is intermediate a transmission and a differential of the work vehicle.

20. The work vehicle of claim 11, the maximum fill level of the cooling fluid is at least 45 millimeters below the drive axis.
